(19) United States
(12) Patent Application Publication
(10) Pub. No.: US 2011/0272133 A1
(43) Pub. Date: Nov. 10, 2011

(54) Systems and Methods for Delivering Gases through a Single Manifold for Remediation

(75) Inventors: Jane Piper, Monterey, CA (US); Anthony Rutland, Freedom, CA (US); Joshua Salvage, Soquel, CA (US)

(73) Assignee: PIPER ENVIRONMENTAL GROUP, INC., CASTROVILLE, CA (US)

(21) Appl. No.: 13/104,003

(22) Filed: May 9, 2011

Related U.S. Application Data
(60) Provisional application No. 61/333,249, filed on May 10, 2010.

(51) Int. Cl. E21B 43/12; G05D 7/06

(52) U.S. Cl. 166/53; 700/282

(57) ABSTRACT

Systems and methods for delivering gases through a single manifold for remediation techniques are described. A system comprises a plurality of gaseous sources and a manifold comprising a plurality of inputs being operable for receiving gases from the gaseous sources, and a plurality of outputs being configured to supply gases to a plurality of injection wells for soil and groundwater remediation. The manifold is further operable for being controlled to select a one of the plurality of inputs and to select a one of the plurality of outputs. A programmable controller is operable for controlling the manifold to select one or more combinations of the plurality of inputs and to select one or more combinations of the plurality of outputs during programmed time intervals.

### CROSS-REFERENCE TO RELATED APPLICATIONS

The present Utility patent application claims priority benefit of the U.S. provisional application for patent Ser. No. 61/333,249 entitled “Method and Device for Delivering Air, Oxygen, and Ozone Gases through a Single Manifold for Remediation”, filed on 10 May 2010 under 35 U.S.C. 119(e). The contents of this related provisional application are incorporated herein by reference for all purposes to the extent that such subject matter is not inconsistent herewith or limiting hereof.

### FEDERALLY SPONSORED RESEARCH OR DEVELOPMENT

Not applicable.

### REFERENCE TO SEQUENCE LISTING, A TABLE, OR A COMPUTER LISTING APPENDIX

Not applicable.

### COPYRIGHT NOTICE

A portion of the disclosure of this patent document contains material that is subject to copyright protection. The copyright owner has no objection to the facsimile reproduction by anyone of the patent document or patent disclosure as it appears in the Patent and Trademark Office, patent file or records, but otherwise reserves all copyright rights whatsoever.

### FIELD OF THE INVENTION

One or more embodiments of the present invention relate to soil and groundwater remediation gas injections and more specifically relate to a method and system for delivering air, oxygen, and ozone gases through a single manifold for remediation for allowing for the injection of different gases or gas mixtures using a single distribution manifold into different injection wells in an injection well field.

### BACKGROUND OF THE INVENTION

The following background information may present examples of specific aspects of the prior art (e.g., without limitation, approaches, facts, or common wisdom) that, while expected to be helpful to further educate the reader as to additional aspects of the prior art, is not to be construed as limiting the present invention, or any embodiments thereof, to anything stated or implied therein or inferred thereupon.

An injection well is typically a vertical pipe in the ground into which water, other liquids, or gases are pumped or allowed to flow.

One application for an injection well is waste water disposal, in which treated waste water is injected into the ground between impermeable layers of rock to avoid polluting fresh water supplies or adversely affecting the quality of underground water supplies. Injection wells are usually constructed of solid wall pipe to a sufficient depth for preventing the injected material from mixing with the surrounding environment.

Another use of injection wells is for the production of petroleum. Steam, carbon dioxide, water and other substances may be injected into an oil-producing well in order to maintain reservoir pressure, heat the oil and/or lower the oils viscosity, thereby allowing the oil to flow and be recovered.

In view of the foregoing, it is clear that these traditional techniques are not perfect and leave room for more optimal approaches.

### BRIEF DESCRIPTION OF THE DRAWINGS

The present invention is illustrated by way of example, and not by way of limitation, in the figures of the accompanying drawings and in which like reference numerals refer to similar elements and in which:

FIG. 1 illustrates a gas injection system, in accordance with an embodiment of the present invention;

FIG. 2 illustrates a gas injection system configurable/controllable via a computing device, in accordance with an embodiment of the present invention;

FIG. 3 illustrates a gas injection system controlled via a drum sequence/timing device, in accordance with an embodiment of the present invention;

FIG. 4A-E illustrates a method for programming a PLC, in accordance with an embodiment of the present invention;

FIG. 5A-G presents a flow chart illustrating the method of programming system using the HMI touch screen, in accordance with an embodiment of the present invention; and

FIG. 6 illustrates a PLC that, when appropriately configured or designed, may serve as a PLC 600 for which the present invention may be embodied.

Unless otherwise indicated illustrations in the figures are not necessarily drawn to scale.

### SUMMARY OF THE INVENTION

To achieve the forgoing and other objects and in accordance with the purpose of the invention, a variety of systems and methods for delivering gases through a single manifold for remediation techniques are described.

In one embodiment a system comprises a plurality of gaseous sources. A manifold comprises a plurality of inputs being operable for receiving gases from the gaseous sources, and a plurality of outputs being configured to supply gases to a plurality of injection wells for soil and groundwater remediation. The manifold further being operable for being controlled to select a one of the plurality of inputs and to select a one of the plurality of outputs. A programmable controller is operable for controlling the manifold to select one or more combinations of the plurality of inputs and to select one or more combinations of the plurality of outputs during programmed time intervals. Another embodiment further comprises a plurality of pumps being operable for feeding the plurality of gaseous sources to the plurality of inputs. Yet another embodiment further comprises one or more generators being operable for generating gaseous sources. In still another embodiment the programmable controller comprises a Programmable Logic Controller (PLC). Another embodiment further comprises a Human Machine Interface (HMI) touch screen for interfacing with and configuring the PLC. Yet another embodiment further comprises a computing device to interface directly with the PLC for making modifications to a gas injection process. In still another embodiment the programmable controller comprises a electro-mechanical sequencer. In another embodiment the programmable controller is further operable to be step programmed. In yet another embodiment a one of the one or more generators comprises an oxygen generator. In still another embodiment a one of the one or more generators comprises an ozone generator.

In another embodiment a system comprises an oxygen generator being operable for generating an oxygen source, a first pump being operable for pressurizing the oxygen source, an ozone generator being operable for generating an ozone source, a second pump being operable for pressurizing the ozone source, and a third pump being operable for pressurizing ambient air. A manifold comprises at least three inputs being operable for receiving gases from the first pump, the second pump and the third pump, and a plurality of outputs being configured to supply gases to a plurality of injection wells for soil and groundwater remediation of contaminates. The manifold further being operable for being controlled to selectively input gases from the at least three inputs and to selectively output gases to the plurality of outputs. A programmable controller is operable for controlling the manifold to select one or more combinations of the plurality of inputs and to select one or more combinations of the plurality of outputs during programmed time intervals. In another embodiment the programmable controller comprises a Programmable Logic Controller (PLC). Yet another embodiment further comprises a Human Machine Interface (HMI) touch screen for interfacing with and configuring the PLC. Still another embodiment further comprises a computing device to interface directly with the PLC for making modifications to a gas injection process. In another embodiment the programmable controller comprises a electro-mechanical sequencer. In still another embodiment the programmable controller is further operable to be step programmed.

In another embodiment a method comprises a step of accessing a programmable controller being configured for step programming to control a system comprising at least a gas generator, a plurality of pumps and a manifold comprising a plurality of inputs being operable for receiving gases, and a plurality of outputs being configured to supply gases to a plurality of injection wells for soil and groundwater remediation of contaminates. The method further comprises a step of accessing a step of the step programming. The method further comprises a step of setting parameters of the step corresponding to selection of inputs and outputs of the manifold and a duration of the step; and enabling the programmable controller to execute the step programming. Another embodiment further comprises a step of setting parameters of the step corresponding to activation of the gas generator. Yet another embodiment further comprises a step of setting the programmable controller to deselect all inputs and outputs of the manifold and deactivate the gas generator following execution of the step programming. Still another embodiment further comprises a step of setting parameters of the step corresponding to deselecting of all inputs and outputs of the manifold and a duration of the step.

Other features, advantages, and objects of the present invention will become more apparent and be more readily understood from the following detailed description, which should be read in conjunction with the accompanying drawings.

### DETAILED DESCRIPTION OF THE PREFERRED EMBODIMENTS

The present invention is best understood by reference to the detailed figures and description set forth herein.

Embodiments of the invention are discussed below with reference to the Figures. However, those skilled in the art will readily appreciate that the detailed description given herein with respect to these figures is for explanatory purposes as the invention extends beyond these limited embodiments. For example, it should be appreciated that those skilled in the art will, in light of the teachings of the present invention, recognize a multiplicity of alternate and suitable approaches, depending upon the needs of the particular application, to implement the functionality of any given detail described herein, beyond the particular implementation choices in the following embodiments described and shown. That is, there are numerous modifications and variations of the invention that are too numerous to be listed but that all fit within the scope of the invention. Also, singular words should be read as plural and vice versa and masculine as feminine and vice versa, where appropriate, and alternative embodiments do not necessarily imply that the two are mutually exclusive.

It is to be further understood that the present invention is not limited to the particular methodology, compounds, materials, manufacturing techniques, uses, and applications, described herein, as these may vary. It is also to be understood that the terminology used herein is used for the purpose of describing particular embodiments only, and is not intended to limit the scope of the present invention. It must be noted that as used herein and in the appended claims, the singular forms “a,” “an,” and “the” include the plural reference unless the context clearly dictates otherwise. Thus, for example, a reference to “an element” is a reference to one or more elements and includes equivalents thereof known to those skilled in the art. Similarly, for another example, a reference to “a step” or “a means” is a reference to one or more steps or means and may include sub-steps and subservient means. All conjunctions used are to be understood in the most inclusive sense possible. Thus, the word “or” should be understood as having the definition of a logical “or” rather than that of a logical “exclusive or” unless the context clearly necessitates otherwise. Structures described herein are to be understood also to refer to functional equivalents of such structures. Language that may be construed to express approximation should be so understood unless the context clearly dictates otherwise.

Unless defined otherwise, all technical and scientific terms used herein have the same meanings as commonly understood by one of ordinary skill in the art to which this invention belongs. Preferred methods, techniques, devices, and materials are described, although any methods, techniques, devices, or materials similar or equivalent to those described herein may be used in the practice or testing of the present invention. Structures described herein are to be understood also to refer to functional equivalents of such structures. The present invention will now be described in detail with reference to embodiments thereof as illustrated in the accompanying drawings.

From reading the present disclosure, other variations and modifications will be apparent to persons skilled in the art. Such variations and modifications may involve equivalent and other features which are already known in the art, and which may be used instead of or in addition to features already described herein.

Although Claims have been formulated in this Application to particular combinations of features, it should be understood that the scope of the disclosure of the present invention also includes any novel feature or any novel combination of features disclosed herein either explicitly or implicitly or any generalization thereof, whether or not it relates to the same invention as presently claimed in any Claim and whether or not it mitigates any or all of the same technical problems as does the present invention.

Features which are described in the context of separate embodiments may also be provided in combination in a single embodiment. Conversely, various features which are, for brevity, described in the context of a single embodiment, may also be provided separately or in any suitable subcombination. The Applicants hereby give notice that new Claims may be formulated to such features and/or combinations of such features during the prosecution of the present Application or of any further Application derived therefrom.

References to “one embodiment,” “an embodiment,” “example embodiment,” “various embodiments,” etc., may indicate that the embodiment(s) of the invention so described may include a particular feature, structure, or characteristic, but not every embodiment necessarily includes the particular feature, structure, or characteristic. Further, repeated use of the phrase “in one embodiment,” or “in an exemplary embodiment,” do not necessarily refer to the same embodiment, although they may.

As is well known to those skilled in the art many careful considerations and compromises typically must be made when designing for the optimal manufacture of a commercial implementation any system, and in particular, the embodiments of the present invention. A commercial implementation in accordance with the spirit and teachings of the present invention may configured according to the needs of the particular application, whereby any aspect(s), feature(s), function(s), result(s), component(s), approach(es), or step(s) of the teachings related to any described embodiment of the present invention may be suitably omitted, included, adapted, mixed and matched, or improved and/or optimized by those skilled in the art, using their average skills and known techniques, to achieve the desired implementation that addresses the needs of the particular application.

In the following description and claims, the terms “coupled” and “connected,” along with their derivatives, may be used. It should be understood that these terms are not intended as synonyms for each other. Rather, in particular embodiments, “connected” may be used to indicate that two or more elements are in direct physical or electrical contact with each other. “Coupled” may mean that two or more elements are in direct physical or electrical contact. However, “coupled” may also mean that two or more elements are not in direct contact with each other, but yet still cooperate or interact with each other.

A “computer” may refer to one or more apparatus and/or one or more systems that are capable of accepting a structured input, processing the structured input according to prescribed rules, and producing results of the processing as output. Examples of a computer may include: a computer; a stationary and/or portable computer; a computer having a single processor, multiple processors, or multi-core processors, which may operate in parallel and/or not in parallel; a general purpose computer; a supercomputer; a mainframe; a super mini-computer; a mini-computer; a workstation; a micro-computer; a server; a client; an interactive television; a web appliance; a telecommunications device with internet access; a hybrid combination of a computer and an interactive television; a portable computer; a tablet personal computer (PC); a personal digital assistant (PDA); a portable telephone; application-specific hardware to emulate a computer and/or software, such as, for example, a digital signal processor (DSP), a field-programmable gate array (FPGA), an application specific integrated circuit (ASIC), an application specific instruction-set processor (ASIP), a chip, chips, a system on a chip, or a chip set; a data acquisition device; an optical computer; a quantum computer; a biological computer; and generally, an apparatus that may accept data, process data according to one or more stored software programs, generate results, and typically include input, output, storage, arithmetic, logic, and control units.

“Software” may refer to prescribed rules to operate a computer. Examples of software may include: code segments in one or more computer-readable languages; graphical and or/textual instructions; applets; pre-compiled code; interpreted code; compiled code; and computer programs.

A “computer-readable medium” may refer to any storage device used for storing data accessible by a computer. Examples of a computer-readable medium may include: a magnetic hard disk; a floppy disk; an optical disk, such as a CD-ROM and a DVD; a magnetic tape; a flash memory; a memory chip; and/or other types of media that can store machine-readable instructions thereon.

A “computer system” may refer to a system having one or more computers, where each computer may include a computer-readable medium embodying software to operate the computer or one or more of its components. Examples of a computer system may include: a distributed computer system for processing information via computer systems linked by a network; two or more computer systems connected together via a network for transmitting and/or receiving information between the computer systems; a computer system including two or more processors within a single computer; and one or more apparatuses and/or one or more systems that may accept data, may process data in accordance with one or more stored software programs, may generate results, and typically may include input, output, storage, arithmetic, logic, and control units.

A “network” may refer to a number of computers and associated devices that may be connected by communication facilities. A network may involve permanent connections such as cables or temporary connections such as those made through telephone or other communication links. A network may further include hard-wired connections (e.g., coaxial cable, twisted pair, optical fiber, waveguides, etc.) and/or wireless connections (e.g., radio frequency waveforms, free-space optical waveforms, acoustic waveforms, etc.). Examples of a network may include: an internet, such as the Internet; an intranet; a local area network (LAN); a wide area network (WAN); and a combination of networks, such as an internet and an intranet.

Exemplary networks may operate with any of a number of protocols, such as Internet protocol (IP), asynchronous transfer mode (ATM), and/or synchronous optical network (SONET), user datagram protocol (UDP), IEEE 802.x, etc.

Embodiments of the present invention may include apparatuses for performing the operations disclosed herein. An apparatus may be specially constructed for the desired purposes, or it may comprise a general-purpose device selectively activated or reconfigured by a program stored in the device.

Embodiments of the invention may also be implemented in one or a combination of hardware, firmware, and software. They may be implemented as instructions stored on a machine-readable medium, which may be read and executed by a computing platform to perform the operations described herein.

In the following description and claims, the terms “computer program medium” and “computer readable medium” may be used to generally refer to media such as, but not limited to, removable storage drives, a hard disk installed in hard disk drive, and the like. These computer program products may provide software to a computer system. Embodiments of the invention may be directed to such computer program products.

An algorithm is here, and generally, considered to be a self-consistent sequence of acts or operations leading to a desired result. These include physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers or the like. It should be understood, however, that all of these and similar terms are to be associated with the appropriate physical quantities and are merely convenient labels applied to these quantities.

Unless specifically stated otherwise, and as may be apparent from the following description and claims, it should be appreciated that throughout the specification descriptions utilizing terms such as “processing,” “computing,” “calculating,” “determining,” or the like, refer to the action and/or processes of a computer or computing system, or similar electronic computing device, that manipulate and/or transform data represented as physical, such as electronic, quantities within the computing system's registers and/or memories into other data similarly represented as physical quantities within the computing system's memories, registers or other such information storage, transmission or display devices.

In a similar manner, the term “processor” may refer to any device or portion of a device that processes electronic data from registers and/or memory to transform that electronic data into other electronic data that may be stored in registers and/or memory. A “computing platform” may comprise one or more processors.

The present invention generally relates to soil and groundwater remediation gas injection which includes the programming of a Programmable Logic Controller (PLC) using step programming to control the injection of gases into a well field and using a Human Machine Interface (HMI) touch screen for interfacing with and configuring the PLC. Furthermore, the programming of a PLC using step programming, a drum timer subroutine or a custom developed subroutine that simulates a drum timer to control the injection of gases into a well field and using a Personal Computer (PC), laptop computer or other computing device to interface directly with the PLC for making modifications to the gas injection process. Furthermore, using a commercial or custom made electro-mechanical drum and hard programming the drum timer to control the injection of gases into a well field and performing modifications to the program controlling the injection of gases into a well field via the modification of cams, pins or other similar devices, without limitation, without the need for a human machine interface.

A first embodiment of the present invention will be described which provides a method and device for delivering air, oxygen, and ozone gases through a single manifold for remediation by allowing for the injection of different gases or gas mixtures using a single distribution manifold into different injection wells in an injection well field.

Other embodiments of the present invention present a method and device for delivering air, oxygen, and ozone gases through a single manifold for remediation and with the ability to oxygenate areas that may often be better remediated by means of bio-remediation and improved oxidative potential (positive Oxidation Reduction Potential (ORP)) of the ground water.

Other embodiments of the present invention present a method and device for delivering air, oxygen, and ozone gases through a single manifold for remediation and with the ability to ozonate areas that may often be better remediated by direct oxidation with a strong oxidant.

Other embodiments of the present invention present a method and device for delivering air, oxygen, and ozone gases through a single manifold for remediation and with the ability to control the level of oxidation in groundwater zones prone to Oxidation By-Products (OBP) such as Bromate from Bromide or Hexavalent Chromium from Trivalent Chromium.

Other embodiments of the present invention present a method and device for delivering air, oxygen, and ozone gases through a single manifold for remediation and with the ability to have a sleep mode that can be programmed as a step at multiple times.

Other embodiments of the present invention present a method and device for delivering air, oxygen, and ozone gases through a single manifold for remediation and with the ability for automatically starting/stopping based upon a 24 hr clock execution in real time.

Other embodiments of the present invention present a method and device for delivering air, oxygen, and ozone gases through a single manifold for remediation and with the ability to provide a selectable button for rapid cycle associated with the distribution manifold and including without limitation variable or fixed time frames for performing fast check of pressure and flow conditions of an associated injection well.

Other embodiments of the present invention present a method and device for delivering air, oxygen, and ozone gases through a single manifold for remediation and with the ability to have a button for selecting an ozone, air or oxygen mode for the system to allow for system gas flow configured without endangering ozone generator power supply.

Other embodiments of the present invention present a method and device for delivering air, oxygen, and ozone gases through a single manifold for remediation with the ability to provide an elapsed hour meter for totaling the time duration that a valve on a distribution manifold has been opened and through mathematical functions record the amount of individual gas that has been injected into an injection point.

The following figures illustrate the programming of a PLC using step programming to control the injection of gases into a well field and using an HMI touch screen to interface with the program. The programming of a PLC using step programming, a drum timer subroutine or a custom developed subroutine that simulates a drum timer to control the injection of gases into a well field and using a computing device to interface directly with the PLC program for making modifications to the gas injection process. Furthermore, the figures illustrate using a commercial or custom made electro-mechanical drum sequence/timer and hard programming the drum sequence/timer to control the injection of gases into a well field and performing modifications to the PLC programming for controlling the injection of gases into a well field via the modification of cams, pins or other similar devices, without the need for a human machine interface.

Furthermore, the figures illustrate using a PLC in conjunction with a computing device to allow field operators to program and re-program when, where and what gases may be injected in an injection well field. Furthermore, the figures illustrate utilizing a drum timer subroutine or custom built program to rotate through the valves in the distribution manifold and selecting the, step, duration and gas or gas mixture to be injected into a particular injection point by changing the settings in a drum time subroutine or loading new variables into a custom built program that reproduces the functions of a drum timer. A means of reducing the number of outputs needed for gas selection may be configured by selecting one gas or gas mixture as the default gas thereby reducing the number of outputs by one.

Furthermore, the figures illustrate utilizing a drum timer subroutine or custom built program to rotate through the valves in the distribution manifold and selecting the, step, duration and gas or gas mixture to be injected into a particular injection point by changing the settings in a drum time subroutine or loading new variables into a custom built program using a series of load, memory, compare, counter, if statements and timing subroutines for reproducing the functions of a drum sequence/timer.

Furthermore, the HMI software/hardware illustrated in the figures may be provided using graphical means.

Furthermore, a means of reducing the number of outputs associated with the drum timer subroutine or custom ladder logic for gas selection may be configured by selecting one gas or gas mixture as the default gas thereby reducing the number of outputs needed by one.

Furthermore, the figures illustrate using an electro-mechanical drum timer to control when, where and what gases may be injected in an injection well field. The programming of electro-mechanical drum timers may be accomplished via the use of cams or pins depending on the manufacturer of the electro-mechanical drum timer. The duration of the injection period may be a function of the electro-mechanical drum sequencer/timer clock motor, length of the cam or the number of pins in the drum. The sequence of injection may be accomplished by either re-wiring the outputs of the electro-mechanical drum timer or the placement of the cams or pins within the time sequence. The selection of gases may be accomplished by placing a corresponding cam(s) or pin(s) on the electro -mechanical drum timer along the same line as the injection point being affected. A means of reducing the number of outputs for gas selection may be configured by setting one gas or gas mixture as the default gas thereby reducing the number of outputs needed by one.

The connections between devices may be accomplished via cables utilizing a wide variety of connectors with non-limiting examples such as USB, Serial Port, RS-232, RJ-11, DB-9 and DB-25 for transferring information bi-directionally between the PLC and the HMI or between the PLC and the computing device.

The connections for the Electro -Mechanical Drum timer may be accomplished via a series of cams, pins and similar devices actuating micro switches and properly rated power cables or wires.

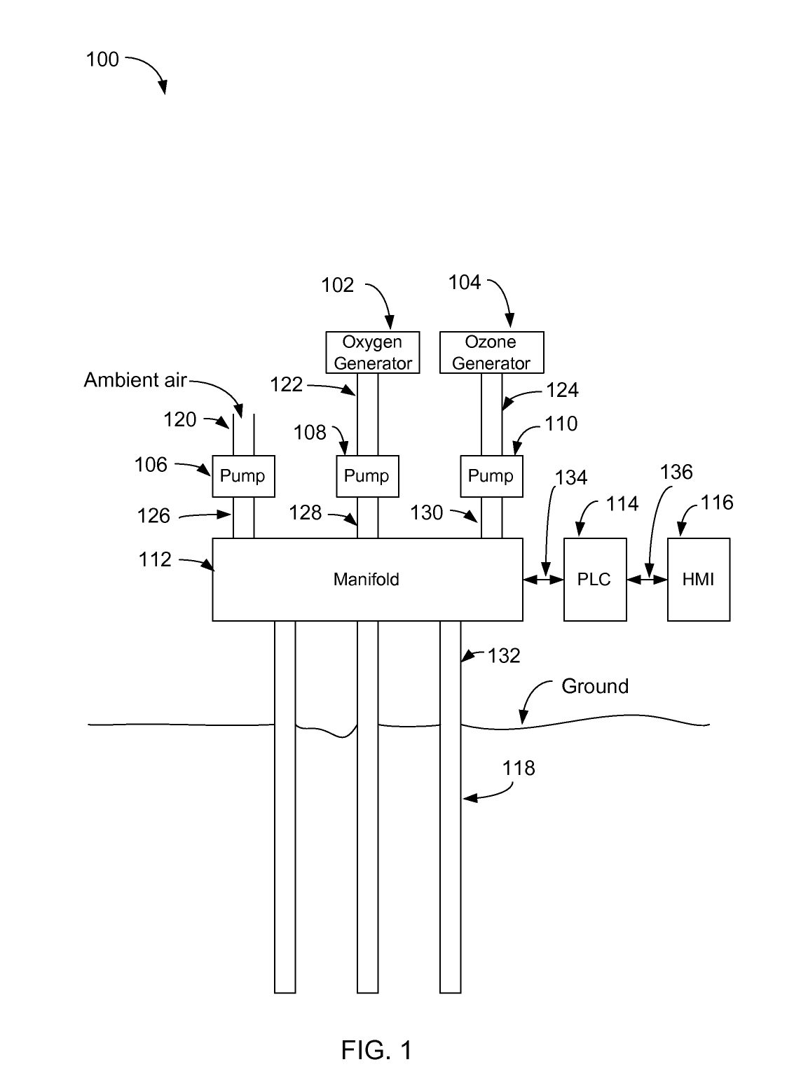

FIG. 1 illustrates a gas injection system, in accordance with an embodiment of the present invention.

A gas injection system 100 includes an oxygen generator 102, an ozone generator 104, a pump 106, a pump 108, a pump 110, a manifold 112, a PLC 114, a HMI 116 and a multiplicity of wells with a sampling denoted as a well 118.

Gas injection system 100 operates to inject a mixture of gasses into wells. As a non-limiting example, gas injection system 100 may operate for purposes of remediation.

Oxygen generator 102 operates to generate oxygen. Ozone generator 104 operates to generate ozone. Pump 106, pump 108 and pump 110 operate to pump gases. Manifold 112 receives and mixes gasses for distribution. PLC 114 controls the operation of manifold 112. HMI 116 enables a user to interface with and configure the operation of PLC 114. Well 118 enables the transfer of gases and liquids to/from the ground.

Pump 106 receives and pumps ambient air via a conduit 120. Pump 108 receives and pumps oxygen via a conduit 122. Pump 110 receives and pumps ozone via a conduit 124.

Manifold 112 receives pressurized ambient air from pump 106 via a conduit 126, receives pressurized oxygen from pump 108 via a conduit 128 and receives pressurized ozone from pump 110 via a conduit 130.

Manifold 112 mixes received ambient air, oxygen and ozone and delivers mixture to well 118 via a conduit 132. As a non-limiting example, manifold 112 may deliver ambient air without oxygen and without ozone to well 118. Furthermore, as a non-limiting example, manifold 112 may deliver oxygen without ambient air and without ozone to well 118. Furthermore, as a non-limiting example, manifold 112 may deliver ozone without ambient air and without oxygen to well 118.

Manifold 112 communicates bi-directionally with PLC 114 via a communication channel 134.

HMI 116 communicates bi-directionally with PLC 114 via a communication channel 136.

PLC 114 may operate to control the mixing of gasses as performed by manifold 112. Furthermore, PLC 114 may control the ratio of the mixture of the gasses as received by manifold 112. Furthermore, PLC 114 may control the timeframe associated with the operation of manifold 112. For example, PLC 114 may configure manifold 112 to deliver a mixture of 10% ambient air, 20% oxygen and 70% ozone to well 118 for 1 minute.

PLC 114 may be programmable and the operation of PLC 114 may be configured for different types of operation depending upon the circumstances.

The configuration of PLC 114 may be controlled and modified via HMI 116. HMI 116 may present and receive information to/from a user for communication to PLC 114.

Gas injection system 100 enables the configuration, mixing and delivery of gasses to a well. A non-limiting example for the use of gas injection system 100 includes remediation.

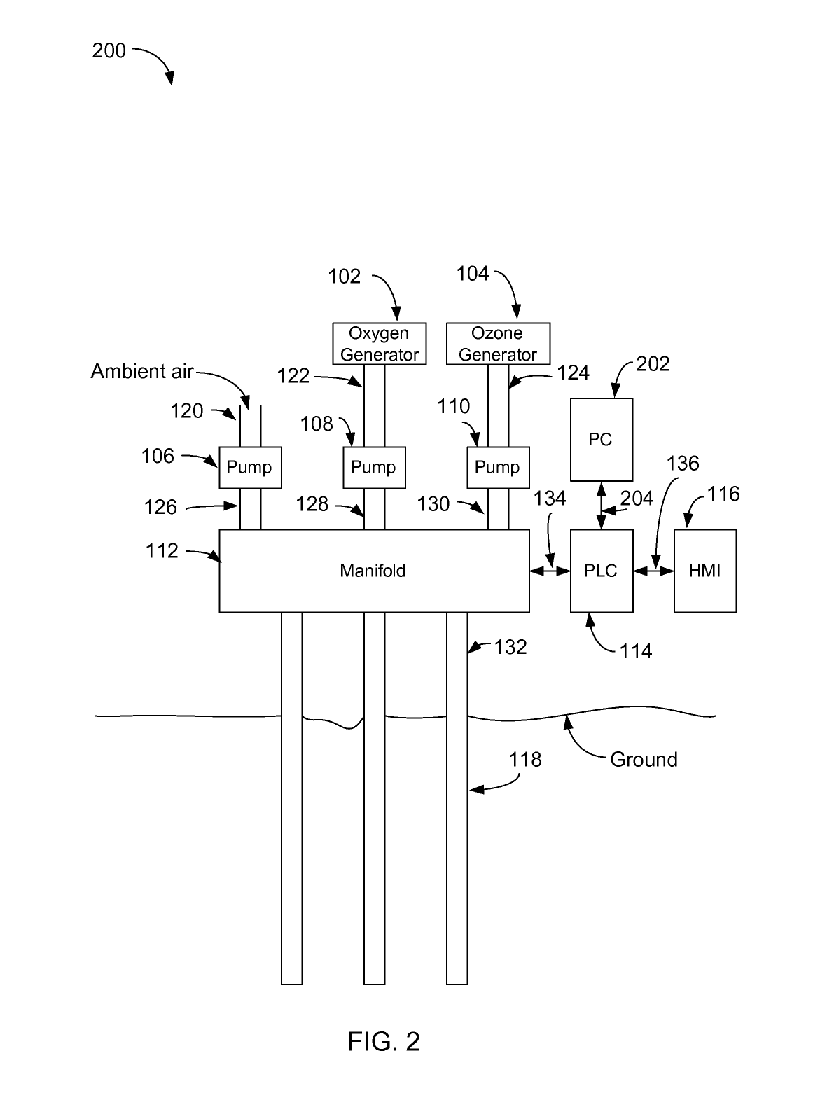

FIG. 2 illustrates a gas injection system configurable/controllable via a computing device, in accordance with an embodiment of the present invention.

A gas injection system 200 includes oxygen generator 102, ozone generator 104, pump 106, pump 108, pump 110, manifold 112, PLC 114, HMI 116, multiplicity of wells with a sampling denoted as well 118 and a computing device 202.

Gas injection system 200 operates to inject a mixture of gasses into wells. As a non-limiting example, gas injection system 200 may operate for purposes of remediation.

Elements of FIG. 2 in common with FIG. 1 will not be described with reference to FIG. 2. The reader may refer to the discussion with regard to FIG. 1 for elements of FIG. 2 in common with FIG. 1.

Computing device 202 communicated bi-directionally with PLC 114 via a communication channel 204.

Computing device 202 may operate to modify the configuration and operation of PLC 114. Non-limiting examples of devices for computing device 202 include personal computer, laptop computer, notebook computer, netbook computer, smartphone, tablet device and cell phone.

Gas injection system 200 enables the configuration, mixing and delivery of gasses to a well. Gas injection system 200 may be configured and controlled via computing device 202. A non-limiting example for the use of gas injection system 200 includes remediation.

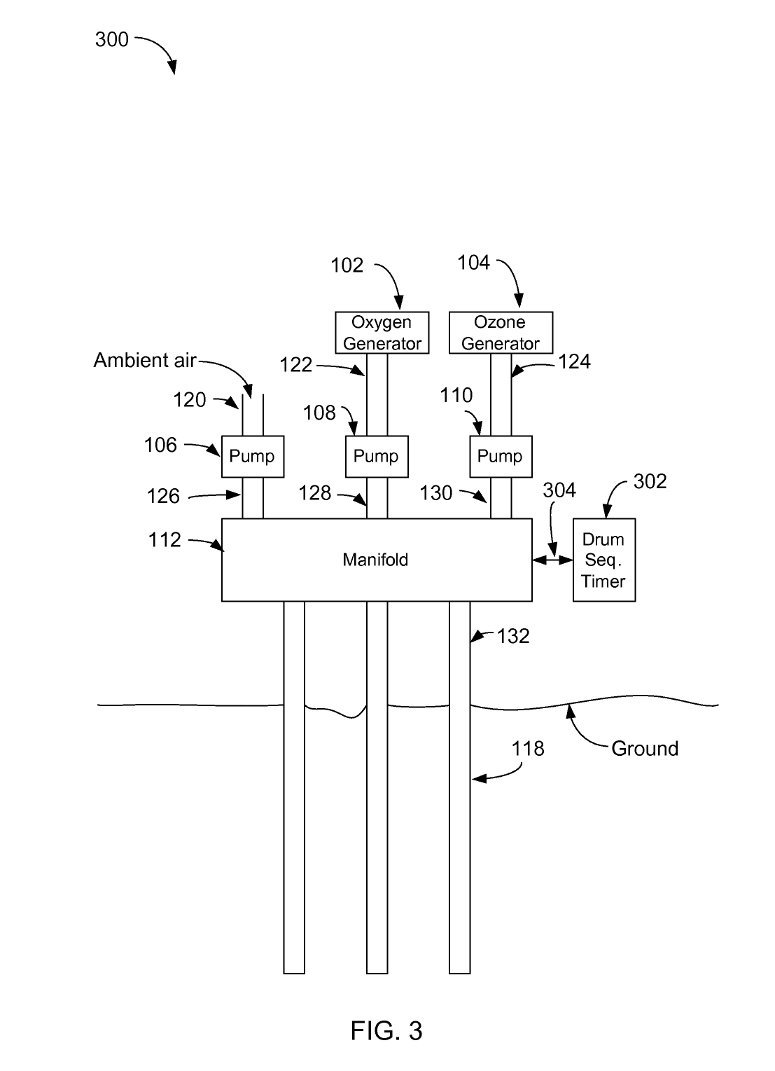

FIG. 3 illustrates a gas injection system controlled via a drum sequence/timing device, in accordance with an embodiment of the present invention.

A gas injection system 300 includes oxygen generator 102, ozone generator 104, pump 106, pump 108, pump 110, manifold 112, multiplicity of wells with a sampling denoted as well 118 and a drum sequencer/timing device 302.

Gas injection system 300 operates to inject a mixture of gasses into wells. As a non-limiting example, gas injection system 300 may operate for purposes of remediation.

Elements of FIG. 3 in common with FIG. 1 will not be described with reference to FIG. 3. The reader may refer to the discussion with regard to FIG. 1 for elements of FIG. 3 in common with FIG. 1.

Drum sequencer/timing device 302 controls the operation of manifold 112. Drum sequencer/timing device 302 operates to control manifold 112 via a communication means 304. Non-limiting examples for communication means 304 include mechanical, electrical, optical and electro-mechanical.

Gas injection system 300 enables the configuration, mixing and delivery of gasses to a well. Gas injection system 300 may be controlled via drum sequencer/timing device 302. A non-limiting example for the use of gas injection system 300 includes remediation.

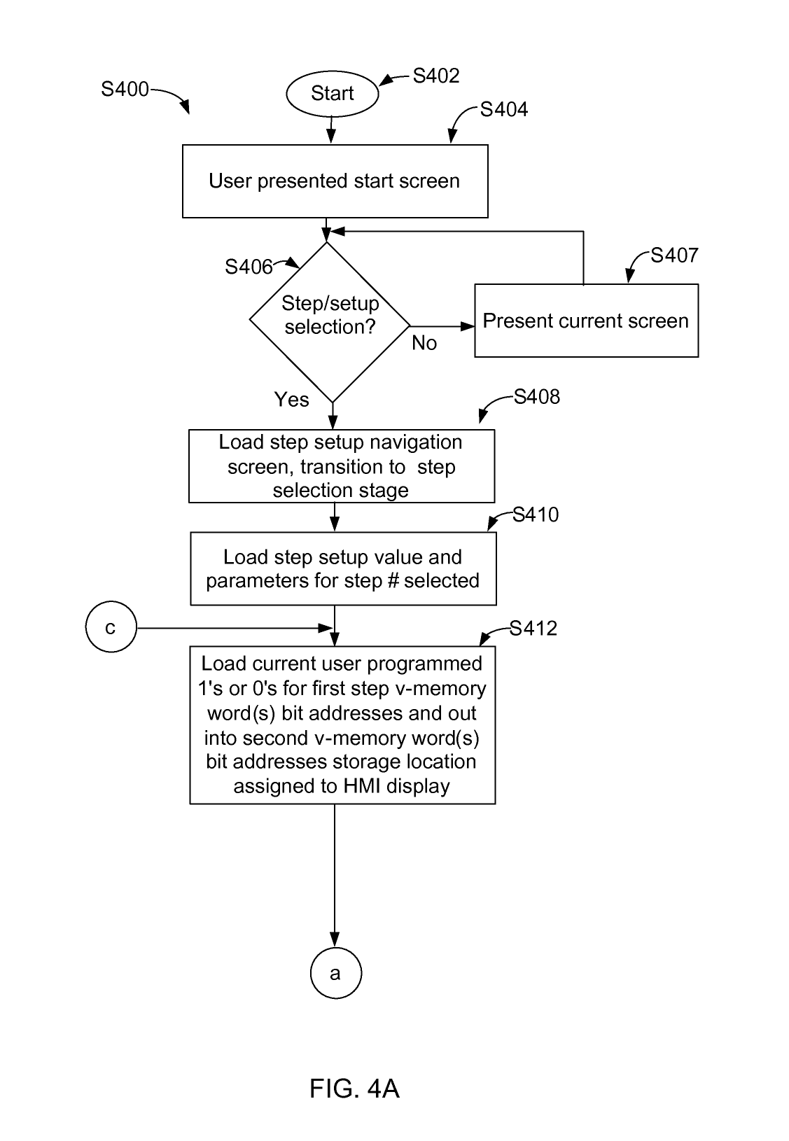

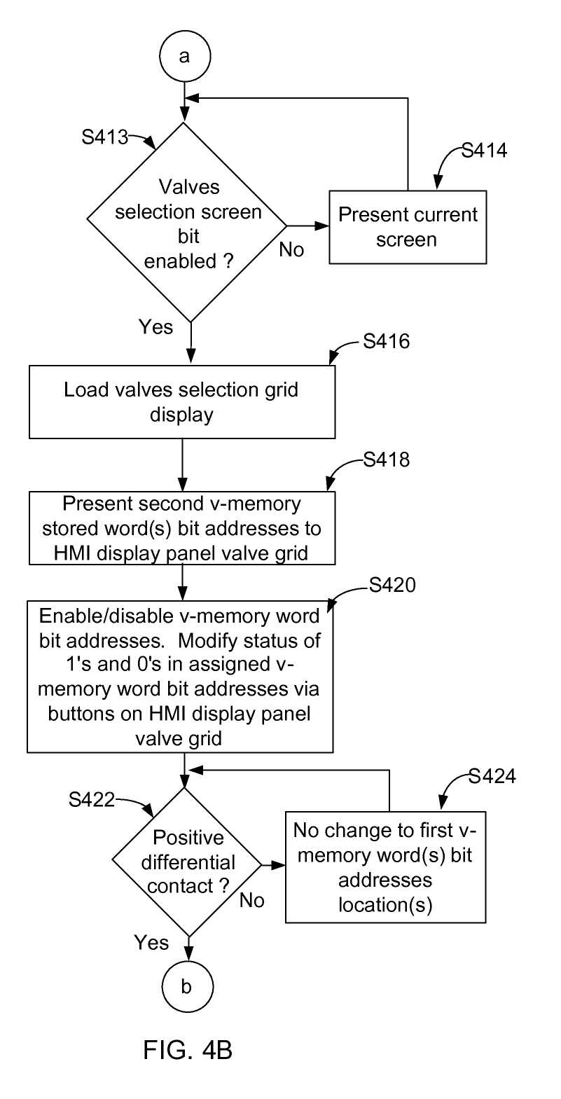

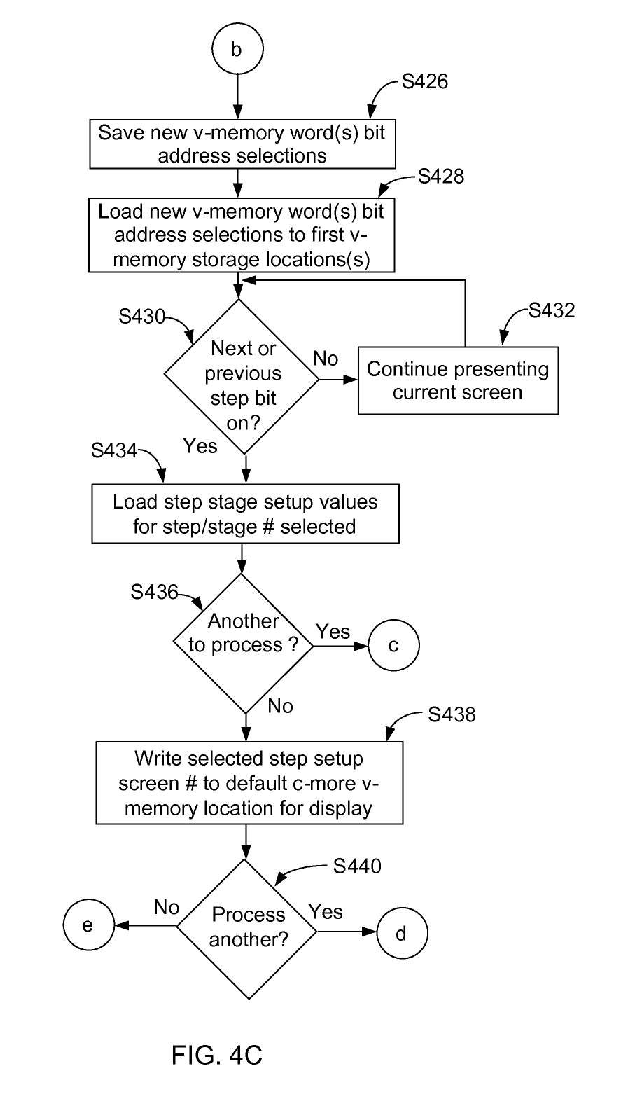

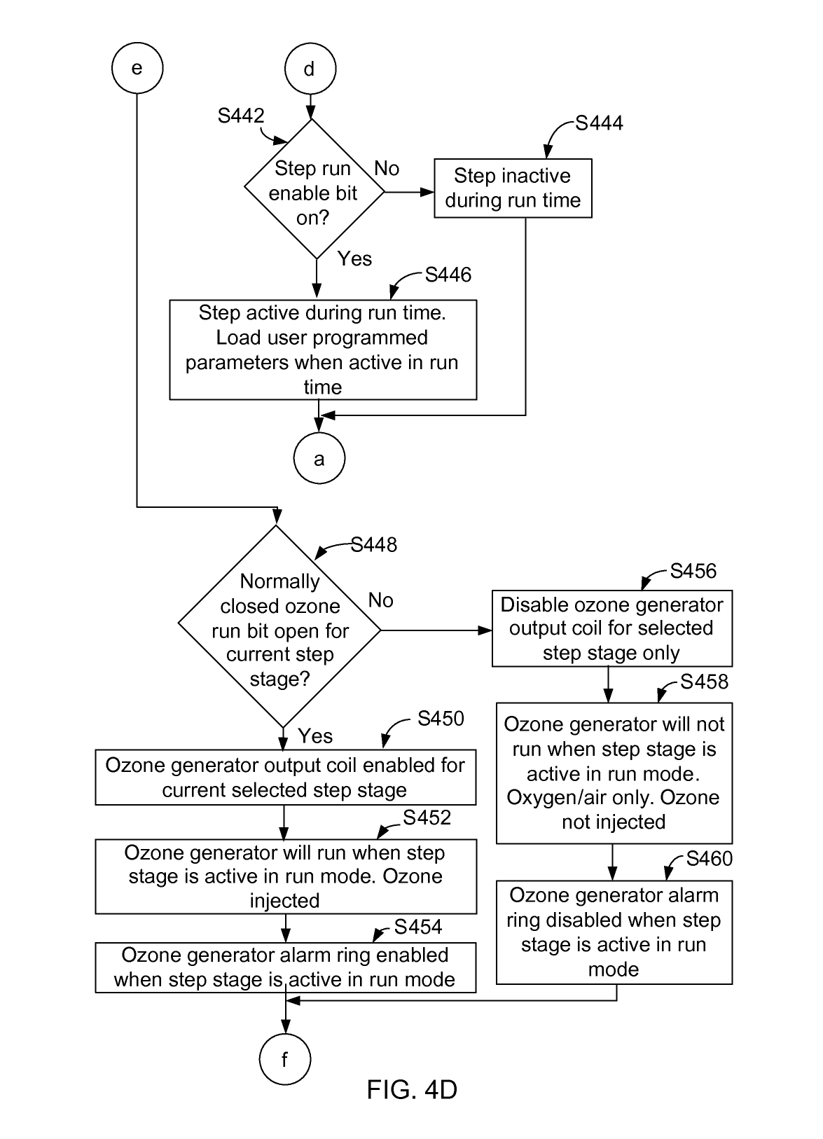

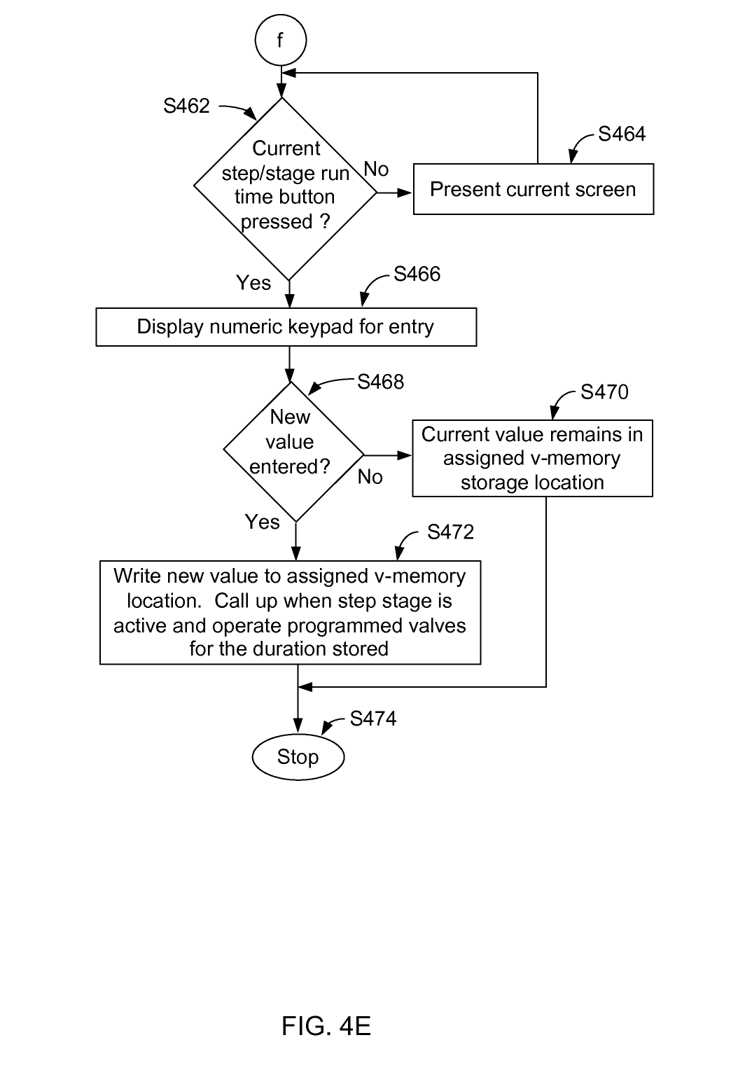

FIG. 4A-E illustrates a method for programming PLC, in accordance with an embodiment of the present invention.

FIG. 4A-E presents a flow chart 400 illustrating an exemplary process for the programming of a PLC using step programming to control the injection of gases into a well using an HMI touch screen for user interface.

A PLC in conjunction with an HMI touch screen enables users to program and re-program the control of gases injected in an injection well field.

In the present embodiment, the process initiates in a step 5402 (FIG. 4A). With the starting point being the start screen on the HMI (S404). User may perform step/setup selection (S406) for navigation to starting step/setup stages to program (S408) the user selected step/setup stage. If not selected, (S407), present current HMI screen. Once selected load parameters and values for step/setup stage selected (S408) and load the selected step/setup stage to assigned v-memory location in c-more panel for display (S410). Loads current user selected V-memory word(s) bit addresses to assigned second V-memory word(s) bit addresses assigned to HMI display which shows which injection points are currently programmed to be on (S412) (FIG. 4B). If the valves selection screen bit enabled (S413) load valves selection display grid (S416) and write V-memory word(s) bit addresses from stored second v-memory address in PLC and write internal bit values to HMI screen for display to show which valves are currently on or off for the step/stage being programmed (S418). If the valves selection screen bit is not enabled, present current screen (S414). User then selects valves/injection points to be on for step/stage being programmed utilizing the HMI display which modifies the V-memory word(s) bit addresses to 1's and 0's of the users choosing (S420). If the user initiates the positive differential contact and it goes true (1) (S422), then the updated 1's and 0's in the V-memory word(s) bit addresses are written (S426) (FIG. 4C) to the first v-memory location assigned to the step/stage being programmed (S428) (FIG. 4C). If the user does not initiate the positive differential contact then present the current display information and no change is performed to the first V-memory word(s) bit addresses (S424) (FIG. 4B). If next step or previous step enabled (S430) (FIG. 4C) load step/stage V-memory word(s) bit addresses for step/stage selected (S434). If next step or previous step is not enabled, present current display information (S432).

For another step/stage to perform (S436), execution of flow chart 400 transitions to S412 (FIG. 4A).

For not another step/stage to perform (S436) (FIG. 4C), step/stage to be programmed is presented on HMI screen (S438). If another step/stage is to be processed (S440) and if step run enable bit on (S442) (FIG. 4D), user chooses to enable step/stage being programmed by pressing the enable button on the HMI screen the step/stage for execution during run time (S446). If another step/stage is to be processed (S440) (FIG. 4C) and if step run enable bit configured as not on (S438) (FIG. 4D), the step/stage currently being programmed is configured for not being executed during run time (S444).

If another step/stage is not to be processed (S440) (FIG. 4C) and if current step/stage being programmed normally closed ozone enable bit on HMI programmed open by user (S448) (FIG. 4D) ozone generator output coil enabled for step/stage currently being programmed (S450). Ozone generator configured for execution during run time, step/stage is executed and ozone injected (S452). Ozone generator alarm ring enabled when step/stage being programmed is executed (S454). If current step/stage being programmed normally closed, ozone enable bit on HMI not programmed open by user (S448) and ozone generator output coil not enabled for step/stage currently being programmed (S456). Ozone generator configured for non-execution during run time when step/stage is executed (S458) oxygen/air. Ozone generator alarm ring disabled when step/stage being programmed is executed (S460).

If the current step/stage being programmed by user run time HMI button is not pressed (S462) (FIG. 4E), then present current screen (S464). If current step/stage being programmed by user run time HMI button is pressed (S462), then display numeric keypad (S466) for step/stage run time when step/stage is executed during run time. If new value entered (S468) write new value to assigned v-memory location and call up programmed run time for step/stage being programmed when step/stage is executed during run time (S472). If no new value entered (S468) on numeric keypad, then current value stored for step/stage being programmed is not changed (S470).

Flow chart 400 terminates execution (S474).

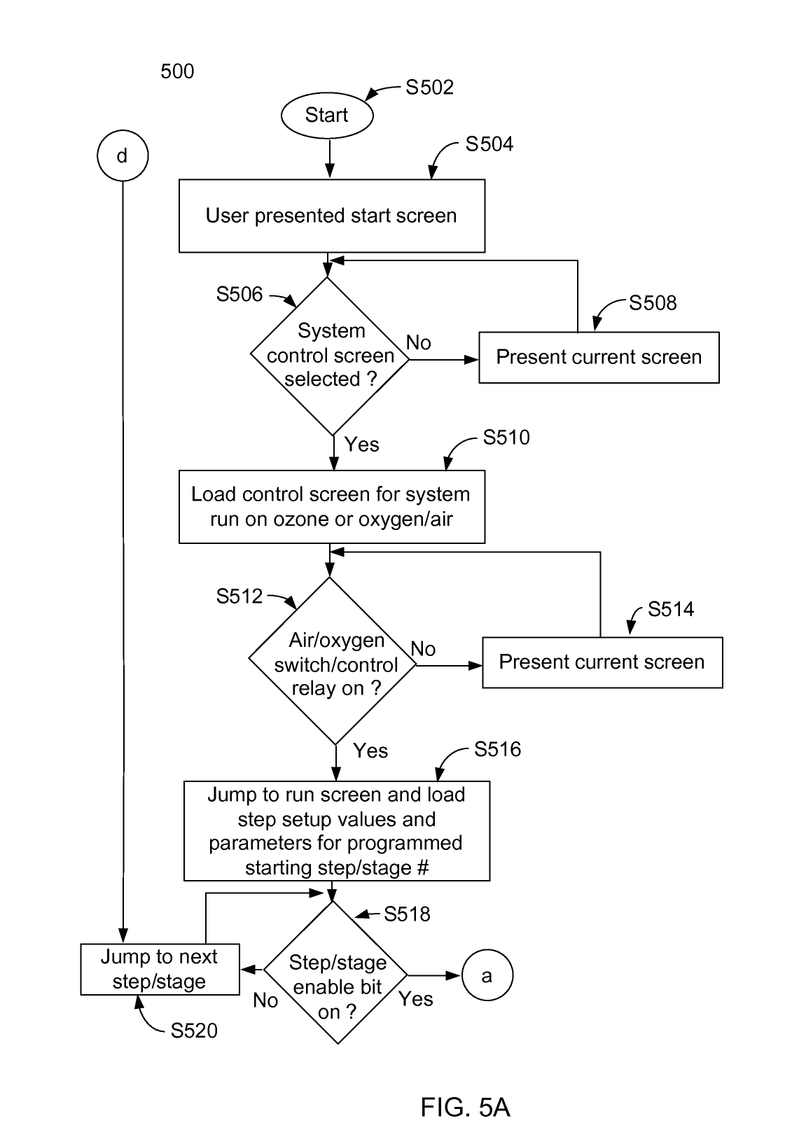

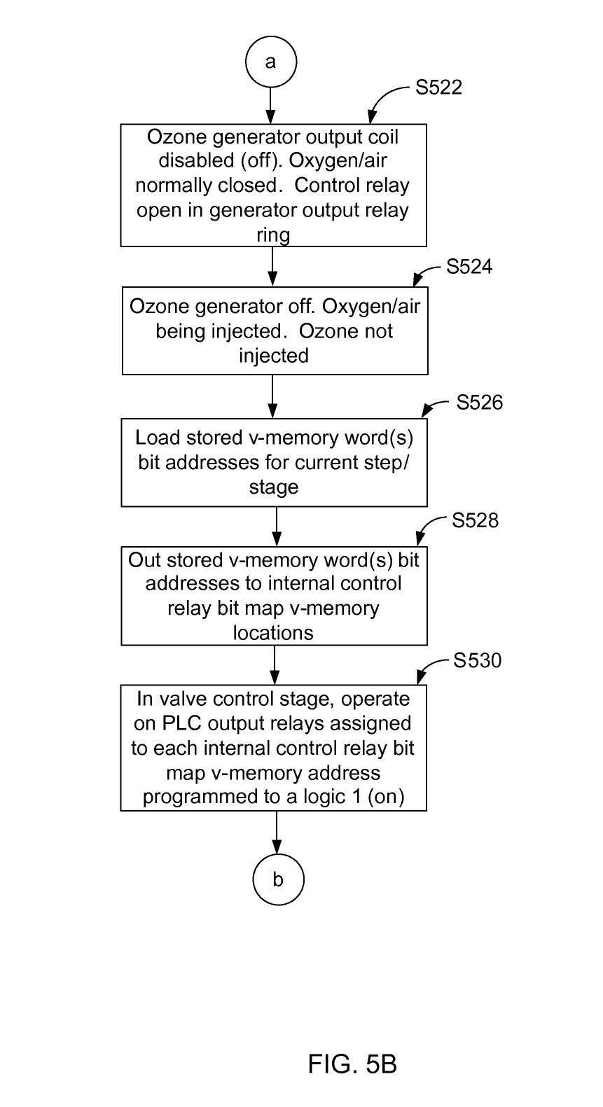

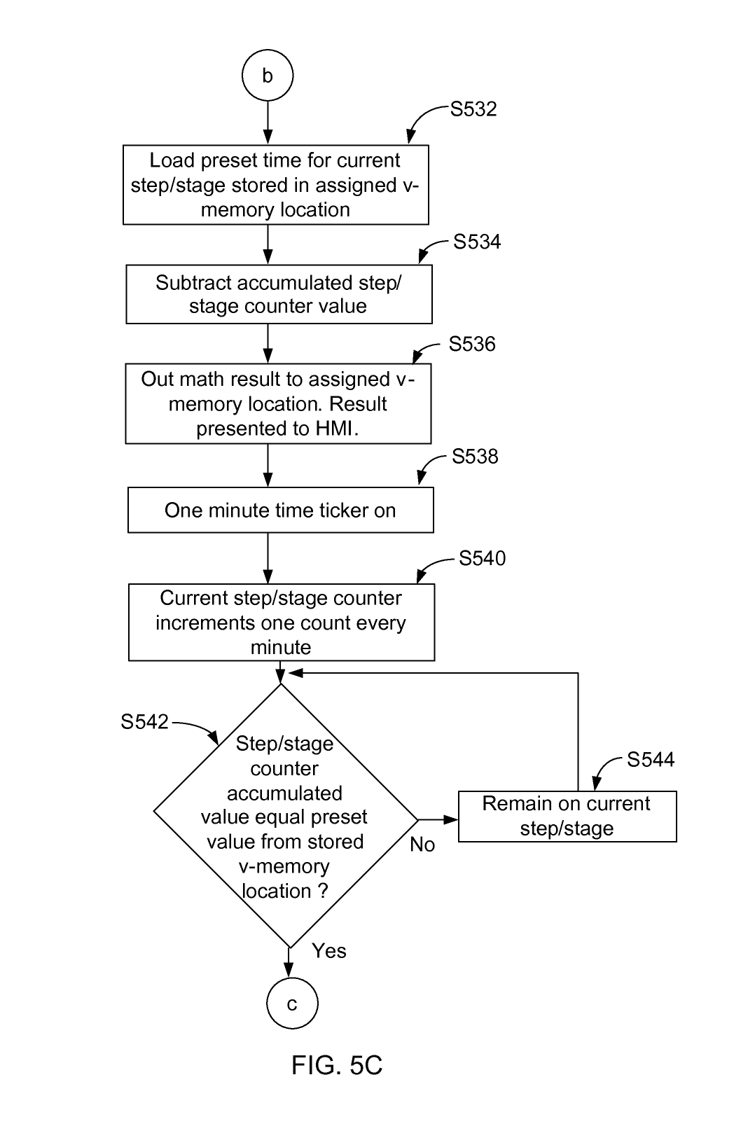

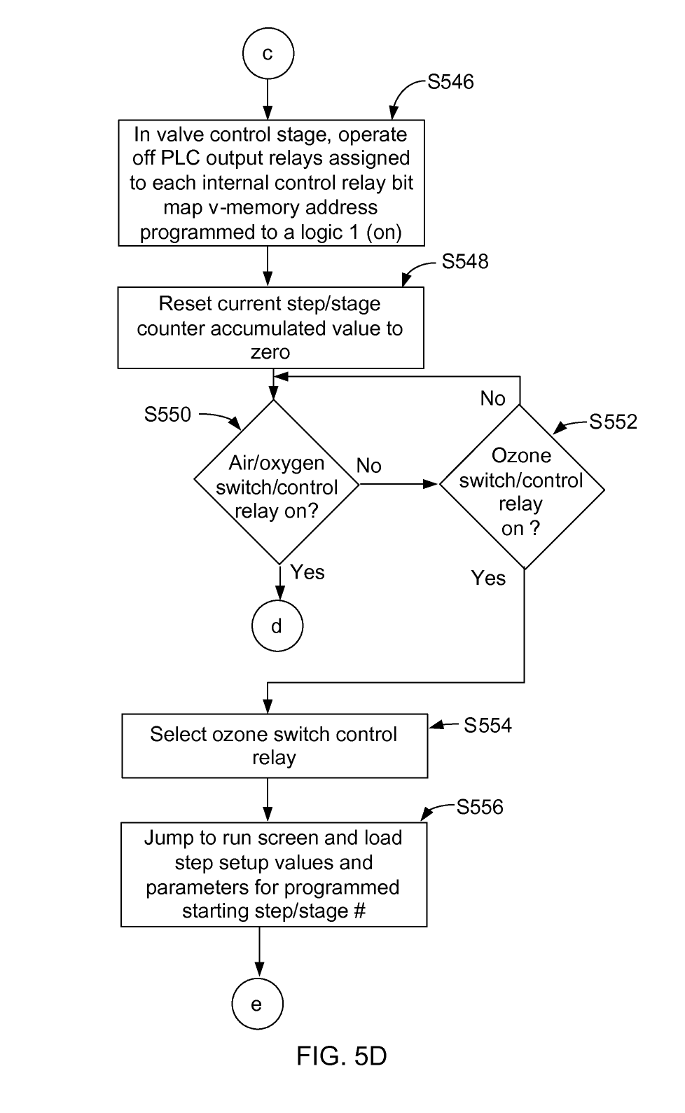

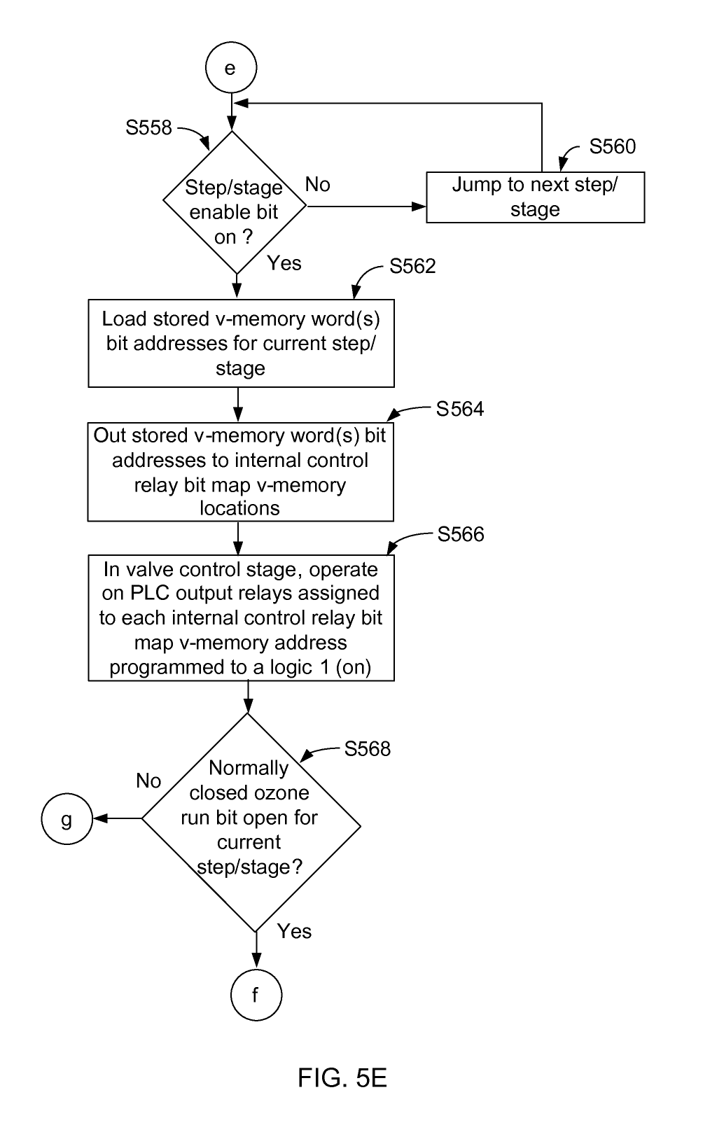

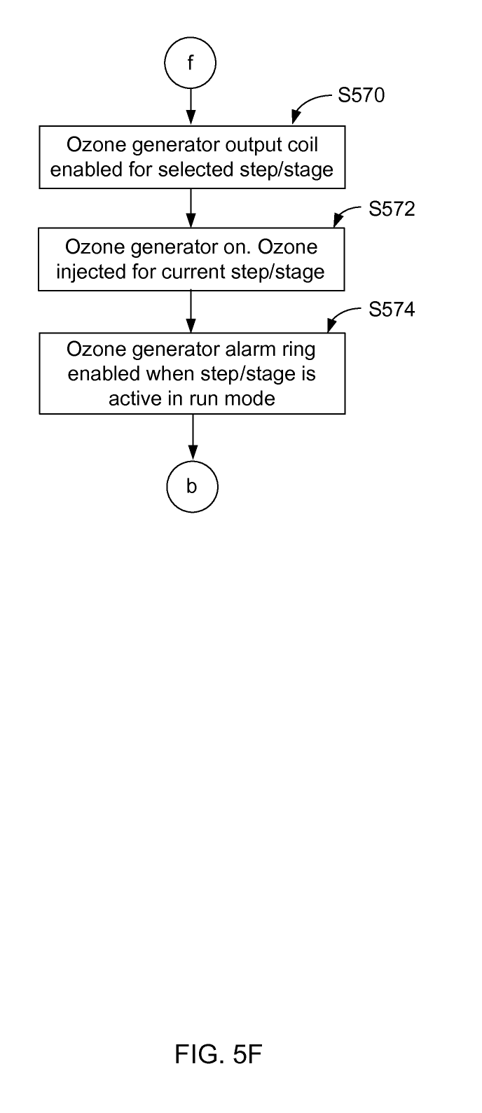

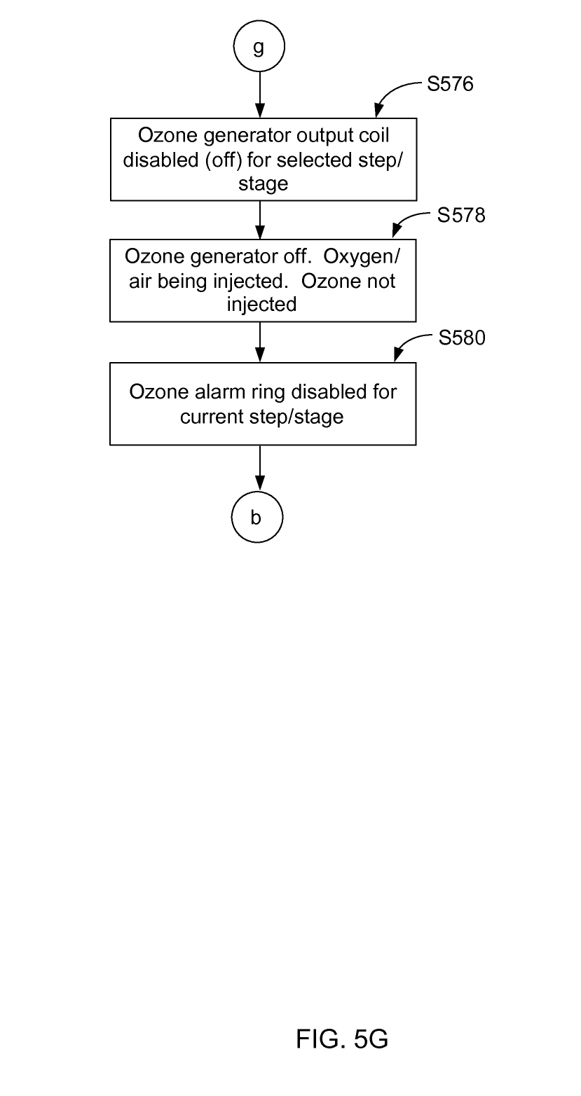

FIG. 5A-G presents a flow chart illustrating the method of programming system using the HMI touch screen, in accordance with an embodiment of the present invention.

In the present embodiment, the process initiates in a step 5502 (FIG. 5A). User presented start screen for viewing (S504). If system control screen selected (S506), load control screen for system start on ozone or oxygen/air (S510). If system control screen not selected (S506) present current display of information (S508). If user does not select air/oxygen control relay to on utilizing the button on the HMI screen display (S512), transition to execute screen for air/oxygen and present current screen (S514).

If user selects air/oxygen control relay to on utilizing the button on the HMI screen display (S512) transition to execute screen for air/oxygen and load step/stage setup values and parameters for the programmed starting step stage selected by the user in setup mode when run time configured for off (S516). If starting step/stage enable bit not on (S518) transition to next optional step/stage (S520). If step/stage enable bit configured for on (S518) ozone generator output coil is disabled, oxygen/air normally closed and control relay open in generator output relay ring (S522) (FIG. 5B). Ozone generator configured for off when current step/stage is executed, oxygen/air is injected for the current step/stage being executed and ozone is not injected (S524). For current step/stage being executed load stored V-memory word(s) bit addresses (S526) and transfer stored V-memory word(s) bit addresses to internal control relay bit map V-memory locations (S528). For valve control stage, configure for operation PLC output relays assigned to associated internal control relay bit map V-memory address programmed to a “one” (on) (S530). Load preset time for current step/stage stored in assigned V-memory location (S532) (FIG. 5C), subtract accumulated step/stage counter value (S534), output mathematical result to assigned V-memory location in HMI for display on the screen (S536), configure one minute time tick counter on (S538) and current step/stage active counter increments one count per minute (S540). If step/stage counter accumulated value not equal to the present value stored in assigned v-memory location for the specific step/stage (S542), then remain on current step/stage (S544). If step/stage counter accumulated value equals the preset value stored in assigned v-memory location for the specific step/stage (S542), then in valve control stage, configure to off PLC output relays assigned to associated internal control relay bit map V-memory address programmed to a “one” (on) (S546) (FIG. 5D). Reset currently active step/stage counter value to “zero” (0) (S548). If air/oxygen switch control relay on (S550) execution of process transitions to step S520 (FIG. 5A). Process repeats until air/oxygen switch control relay is exercised to the off position (S550). If air/oxygen switch control relay is not on, then determine if ozone switch control relay configured for on (S552). If ozone switch/control relay not configured for on (S552), then determine if air/oxygen switch/control relay configured for on (S550).

If ozone switch/control relay configured for on (S552), then user selects ozone switch control relay to on (S554) utilizing the button on the HMI screen display. Present execute screen for ozone and load step/stage setup values and parameters for the programmed starting step stage selected by the user in setup mode when run time configured for off (S556). If starting step/stage enable bit not on (S558) (FIG. 5E) jump to next step/stage (S560). If step/stage enable bit configured for on (S558), load stored V-memory word(s) bit addresses (S562), output stored V-memory word(s) bit addresses to internal control relay bit map V-memory locations (S564) and input valve control stage operate on PLC output relays assigned to associated internal control relay bit map V-memory address programmed to a “one” (on) (S566). If normally closed ozone run bit open for current step/stage (S568), then ozone generator output coil enabled for current selected step/stage (S570) (FIG. 5F) ozone generator configured for on, ozone injected for current step/stage (S572) and ozone generator alarm ring enabled when step/stage is being executed in PLC run mode (S574). If normally closed ozone run bit not open for current step/stage (S568) (FIG. 5E), then ozone generator output coil disabled (off) for selected step/stage (S576) (FIG. 5G) ozone generator off, air/oxygen injected, ozone not injected (S578) and ozone generator alarm ring disabled for current active step/stage (S580). Execution of process transitions to step 5532 (FIG. 5C). Process repeats until ozone switch control relay exercised to the off position.

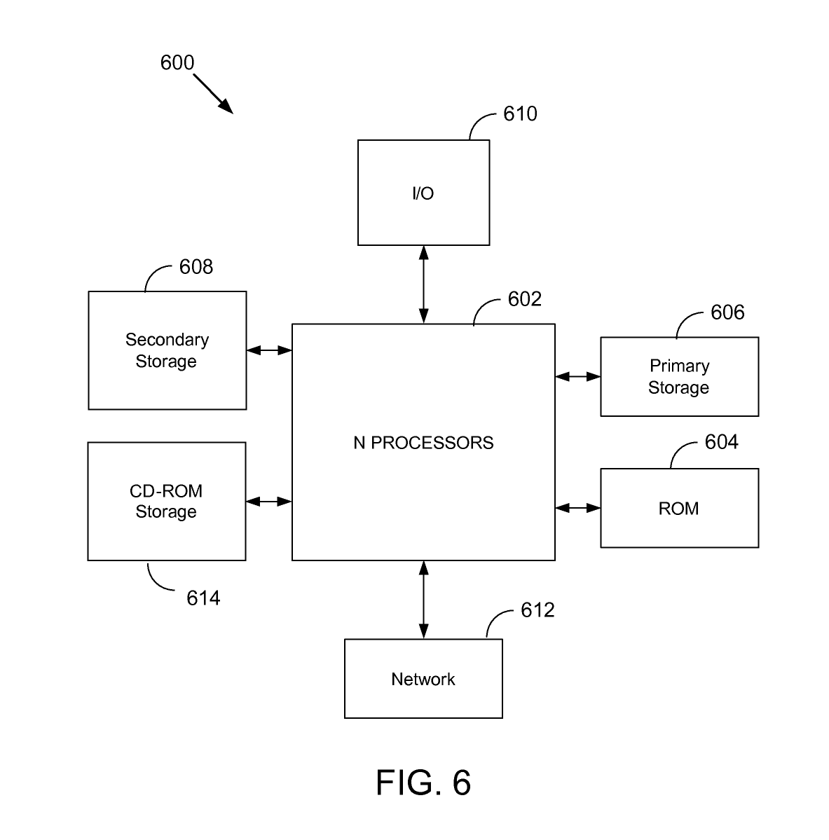

FIG. 6 illustrates a PLC that, when appropriately configured or designed, may serve as a PLC 600 for which the present invention may be embodied.

PLC 600 includes a quantity of processors 602 (also referred to as central processing units, or CPUs) that may be coupled to storage devices including a primary storage 606 (typically a random access memory, or RAM), a primary storage 604 (typically a read only memory, or ROM). CPU 602 may be of various types including micro-controllers (e.g., with embedded RAM/ROM) and microprocessors such as programmable devices (e.g., RISC or SISC based, or CPLDs and FPGAs) and devices not capable of being programmed such as gate array ASICs (Application Specific Integrated Circuits) or general purpose microprocessors. As is well known in the art, primary storage 604 acts to transfer data and instructions uni-directionally to the CPU and primary storage 606 is used typically to transfer data and instructions in a bi-directional manner. The primary storage devices discussed previously may include any suitable computer-readable media such as those described above. A mass storage device 608 may also be coupled bi-directionally to CPU 602 and provides additional data storage capacity and may include any of the computer-readable media described above. Mass storage device 608 may be used to store programs, data and the like and is typically a secondary storage medium such as a hard disk. It will be appreciated that the information retained within mass storage device 608, may, in appropriate cases, be incorporated in standard fashion as part of primary storage 606 as virtual memory. A specific mass storage device such as a CD-ROM 614 may also pass data uni-directionally to the CPU.

CPU 602 may also be coupled to an interface 610 that connects to one or more input/output devices such as such as video monitors, track balls, mice, keyboards, microphones, touch-sensitive displays, transducer card readers, magnetic or paper tape readers, tablets, styluses, voice or handwriting recognizers, or other well-known input devices such as, of course, other computers. Finally, CPU 602 optionally may be coupled to an external device such as a database or a computer or telecommunications or internet network using an external connection shown generally as a network 612, which may be implemented as a hardwired or wireless communications link using suitable conventional technologies. With such a connection, the CPU might receive information from the network, or might output information to the network in the course of performing the method steps described in the teachings of the present invention.

Those skilled in the art will readily recognize, in light of and in accordance with the teachings of the present invention, that any of the foregoing optional steps and/or system modules may be suitably replaced, reordered, removed and additional optional steps and/or system modules may be inserted depending upon the needs of the particular application, and that the systems of the foregoing embodiments may be implemented using any of a wide variety of suitable processes and system modules, and is not limited to any particular computer hardware, software, middleware, firmware, microcode and the like. For any method steps described in the present application that can be carried out on a computing machine, a typical computer system can, when appropriately configured or designed, serve as a computer system in which those aspects of the invention may be embodied.

All the features disclosed in this specification, including any accompanying abstract and drawings, may be replaced by alternative features serving the same, equivalent or similar purpose, unless expressly stated otherwise. Thus, unless expressly stated otherwise, each feature disclosed is one example only of a generic series of equivalent or similar features.

Having fully described at least one embodiment of the present invention, other equivalent or alternative methods of delivering air, oxygen, and ozone gases through a single manifold for remediation for allowing for the injection of different gases or gas mixtures using a single distribution manifold into different injection wells in an injection well field according to the present invention will be apparent to those skilled in the art. The invention has been described above by way of illustration, and the specific embodiments disclosed are not intended to limit the invention to the particular forms disclosed. For example, the particular implementation of the PLC and HMI may vary depending upon the particular type manifold used. The system described in the foregoing was directed to water well implementations; however, similar techniques are applicable for other types of well implementations of the present invention and are contemplated as within the scope of the present invention. The invention is thus to cover all modifications, equivalents, and alternatives falling within the spirit and scope of the following claims.

Claim elements and steps herein may have been numbered and/or lettered solely as an aid in readability and understanding. Any such numbering and lettering in itself is not intended to and should not be taken to indicate the ordering of elements and/or steps in the claims.

What is claimed is:

1. A system comprising:
a plurality of gaseous sources;
a manifold comprising a plurality of inputs being operable for receiving gases from said gaseous sources, and a plurality of outputs being configured to supply gases to a plurality of injection wells for soil and groundwater remediation, said manifold further being operable for being controlled to select a one of said plurality of inputs and to select a one of said plurality of outputs; and
a programmable controller being operable for controlling said manifold to select one or more combinations of said plurality of inputs and to select one or more combinations of said plurality of outputs during programmed time intervals.

2. The system as recited in claim 1, further comprising a plurality of pumps being operable for feeding said plurality of gaseous sources to said plurality of inputs.

3. The system as recited in claim 1, further comprising one or more generators being operable for generating gaseous sources.

4. The system as recited in claim 1, in which said programmable controller comprises a Programmable Logic Controller (PLC).

5. The system as recited in claim 4, further comprising a Human Machine Interface (HMI) touch screen for interfacing with and configuring the PLC.

6. The system as recited in claim 4, further comprising a computing device to interface directly with the PLC for making modifications to a gas injection process.

7. The system as recited in claim 1, in which said programmable controller comprises a electro-mechanical sequencer.

8. The system as recited in claim 1, in which said programmable controller is further operable to be step programmed.

9. The system as recited in claim 3, in which a one of said one or more generators comprises an oxygen generator.

10. The system as recited in claim 3, in which a one of said one or more generators comprises an ozone generator.

11. A system comprising:
an oxygen generator being operable for generating an oxygen source;
a first pump being operable for pressurizing the oxygen source;
an ozone generator being operable for generating an ozone source;
a second pump being operable for pressurizing the ozone source;
a third pump being operable for pressurizing ambient air;
a manifold comprising at least three inputs being operable for receiving gases from said first pump, said second pump and said third pump, and a plurality of outputs being configured to supply gases to a plurality of injection wells for soil and groundwater remediation of contaminates, said manifold further being operable for being controlled to selectively input gases from said at least three inputs and to selectively output gases to said plurality of outputs; and
a programmable controller being operable for controlling said manifold to select one or more combinations of said plurality of inputs and to select one or more combinations of said plurality of outputs during programmed time intervals.

12. The system as recited in claim 11, in which said programmable controller comprises a Programmable Logic Controller (PLC).

13. The system as recited in claim 12, further comprising a Human Machine Interface (HMI) touch screen for interfacing with and configuring the PLC.

14. The system as recited in claim 12, further comprising a computing device to interface directly with the PLC for making modifications to a gas injection process.

15. The system as recited in claim 11, in which said programmable controller comprises a electro-mechanical sequencer.

16. The system as recited in claim 11, in which said programmable controller is further operable to be step programmed.

17. A method comprising steps of:
accessing a programmable controller being configured for step programming to control a system comprising at least a gas generator, a plurality of pumps and a manifold comprising a plurality of inputs being operable for receiving gases, and a plurality of outputs being configured to supply gases to a plurality of injection wells for soil and groundwater remediation of contaminates;
accessing a step of the step programming;
setting parameters of the step corresponding to selection of inputs and outputs of the manifold and a duration of the step; and
enabling the programmable controller to execute the step programming.

18. The method as recited in claim 17, further comprising a step of setting parameters of the step corresponding to activation of the gas generator.

19. The system as recited in claim 18, further comprising a step of setting the programmable controller to deselect all inputs and outputs of the manifold and deactivate the gas generator following execution of the step programming.

20. The system as recited in claim 17, further comprising a step of setting parameters of the step corresponding to deselecting of all inputs and outputs of the manifold and a duration of the step.
